(19) United States
(12) Patent Application Publication
(10) Pub. No.: US 2013/0199103 A1
(43) Pub. Date: Aug. 8, 2013

(54) METHOD AND DEVICE FOR APPLYING A SEAL TO A SURFACE OF A DEVICE HOUSING FOR A MOTOR VEHICLE

(71) Applicants: Peter Raschegewski, Heiligenhaus (DE); Armin Handke, Duisburg (DE); Andreas Sohlbach, Mulheim (DE); Matthias Ochtrop, Dorsten (DE)

(72) Inventors: Peter Raschegewski, Heiligenhaus (DE); Armin Handke, Duisburg (DE); Andreas Sohlbach, Mulheim (DE); Matthias Ochtrop, Dorsten (DE)

(73) Assignee: KIEKERT AKTIENGESELLSCHAFT, Heiligenhaus (DE)

(21) Appl. No.: 13/812,859

(22) PCT Filed: Jul. 21, 2011
(86) PCT No.: PCT/DE2011/001502

§ 371 Date: Mar. 18, 2013

(30) Foreign Application Priority Data
Jul. 29, 2010 (DE) 10 2010 032 744.1

(51) Int. Cl. E06B 7/16

(52) U.S. Cl. CPC E06B 7/16
USPC 49/506; 118/58; 118/641

(57) ABSTRACT

A procedure for the application of a seal (3) onto a surface of a device housing (1,2) for a motor vehicle, especially a motor vehicle door lock housing surface, comprising the following procedural steps: the surface is at least partially cleaned and/or micro structured by a heat source (4) restricted in area; and a sealant is applied to areas of the surface treated in such a way.

### FIELD OF THE INVENTION

The invention relates to a procedure and pertaining equipment for the application of a seal onto a surface of a device housing for a motor vehicle.

### BACKGROUND OF THE INVENTION

The device housing in question is usually a motor vehicle door lock housing. Consequently, the invention regularly involves applying a seal onto a motor vehicle door lock housing surface.

The purpose of device housings for motor vehicles, for example, is to accommodate controls, engines, window raising equipment, motor vehicle door locks, lock cylinders, remote controls, etc. What all device housings have in common is that they regularly need to be locked firmly and durably. Because the penetration of water, dirt, etc. cannot be durably and reliably precluded in a motor vehicle. This is why special significance is attributed to the protection of the units located in the interior of the device housing.

Furthermore, such device housings serve in addition to or instead of the sealing of openings in the bodywork, as is the case for example for motor vehicle door lock housings. In actual fact, such motor vehicle door lock housings are usually located in the region of a recess or notch in the inside of a lateral door, the tailgate, etc. The recess is necessary to enable a lock pin which may be present on a column of the motor vehicle bodywork, for example, to penetrate into the motor vehicle door lock and to be reliably blocked here by the locking mechanism, comprising of a rotary latch and locking pawl here. This also applies to the lateral door, tailgate, etc. associated with the motor vehicle door lock. In this case, the recess which is usually present in an internal panel of the lateral door is sealed with the aid of a seal which is accommodated on an external surface of the device housing, in the present case on an external surface of the motor vehicle door lock housing.

The attachment or insertion of such seals on device housings for a motor vehicle places special requirements on the manufacturing procedure. Because, as already described, the seal must durably retain its elasticity, typically for far more than ten years, and must ensure a reliable seal. What is more, the cost pressure on the automotive sector in particular is enormous, consequently cost-effective solutions are demanded at the same time. Namely, in the state of the art, in accordance with DE 197 55 497 C1 for example, there are already objectives to the extent that a plastic control device housing for a vehicle can be sealed up quickly and easily. To this end and at this point, recourse is had to a plastic welding procedure with the help of which the floor of the housing and the lid of the housing of the aforementioned device housing are hermetically sealed. The plastic welding can be accomplished by a laser welding process. However, it is a pre-requisite for the aforementioned theory that both the floor of the housing and the lid of the housing are respectively made of plastic.

Furthermore, EP 0 709 532 A1 describes a lock cylinder for a motor vehicle door lock which is equipped with a cover flap. An elastic seal is affixed to the cover flap. This occurs mechanically and not adhesively.

The aforementioned procedures cannot convince in all respects. For example, the plastic welding procedure from DE 197 55 497 C1 cannot be directly transferred to a metal device housing. Upon perusal of EP 0 709 532 A1, it is apparent that mechanical fixtures are necessary for the seal. An adhesive application of the seal is hereby not possible. Furthermore, complicated three-dimensional seal shapes are almost impossible to accomplish in this way or to connect perfectly with the pertaining device housing. This is where the invention comes into play.

### SUMMARY OF THE INVENTION

The invention is based on the technical problem of thus further developing such a procedure that practically any seal shapes can be accomplished, whilst nevertheless guaranteeing perfect adhesion of the sealing material, in fact on metallic surfaces too under certain circumstances.

In order to solve this technical problem, the invention suggests initially cleaning and/or micro structuring the surface at least partially by a heat source which is limited in its area with a procedure for applying a seal onto a surface of a device housing for a motor vehicle. The cleaning and micro structuring process is followed by the actual attachment or insertion of the seal. Because a preferably hardening sealant is applied to the areas of the surface treated in such a way. The sealant is therefore adhesively attached to the surface.

Generally, the surface of the device housing to be treated is the external surface of the device housing in question. This means that the seal is usually applied onto the outside of the device housing as part of the invention. The device housing in conjunction with seal defined on the outside is therefore capable of firmly sealing an opening which may be present on the motor vehicle bodywork, for example, behind which the device housing is placed or mounted. A typical case of application is for a motor vehicle door lock housing being firmly sealed externally as a device housing of a recess present in an internal panel of a motor vehicle door and intended for the penetration of the lock pin. Naturally, the invention is not limited to this.

The invention envisages a special pre-treatment of the surface which is subsequently to be equipped with the sealant. Because this surface is cleaned or microstructured. This happens with a heat source which is restricted in area, i.e. a heat source which does not completely impact the surface, but typically only in the area or areas which are subsequently equipped with the seal. This means that the surface only experiences the described heat treatment in the area of the subsequently applied sealant. This is advantageously attained with the heat source which is restricted in area.

Thus, the manufacturing process can already be outlined quickly and efficiently because only very narrowly delineated or defined areas of the surface to be equipped with the seal experience the described treatment. This can occur quickly, efficiently and cost-effectively with the heat source which is restricted in area.

As usually the external surface of the device housing in question experiences the described treatment, the invention further recommends that the heat source or the surface in question can be moved against one another. This enables any shaped, treated areas to be defined. Generally, three-dimensional movement is possible between the heat source on the one hand and the surface to be treated on the other. This means that the heat source and/or the surface execute a mutual three-dimensional movement. This enables the external surface of the device housing to be treated practically along any contouring of the external surface in question, especially also in three dimensions. Also, in this way, device housings of variable designs can experience the desired processing.

Designing is usually such that the heat source only impacts the surface in an area near to the surface. For example, this can attain up to 500 μm in material depth, especially up to 100 μm in material depth. This guarantees that the device housing in question is not especially strongly heated on the one hand and does not experience any structural changes on the other hand. Because, actually only areas near to the surface are ascertained as part of the described heat treatment. This also enables the energy input to be limited to the surface to be treated, which in turn minimises costs and reduces manufacturing time.

Measures of the invention also have the same aim to the extent that the heat source processes the surface in a pulsed manner. Short pulse times in the region of one millisecond and less are usually worked with, i.e. into the nanosecond region.

It has also been proven when an electromagnetic source of radiation is used as a heat source which is preferably classed in the infrared range and here in the far infrared range (FIR). It is actually recommended to use an IR laser as a heat source and here especially a CO₂ laser. Its emitted laser light demonstrates a wavelength of approx. 10.6 μm and is therefore classed considerably above the visible range. Radiation outputs of a maximum of 200 W are typically observed, which are completely sufficient for the described applications.

Furthermore, it is recommended to focus the emitted light of the IR laser or the heat source if necessary. Actually, CO₂ lasers typically have a diameter without focussing which is classed in the range between 3 and 20 mm. Dependent on the case of application and the size of the area to be treated, the emitted light of the CO₂ laser can be directly oriented to the device housing to be treated with or without focussing. Mirror and/or focussing optics are worked with to this end.

Thus, the surface of the device housing in question is chemically prepared and cleaned and/or microstructured. This enables the sealant to be subsequently applied and for it to adhere particularly well. This can essentially be attributed to the fact that the surface experiences cleaning and/or microstructuring due to the heat treatment pertaining to the invention. As part of the cleaning process, any liquid residues from upstream manufacturing processes are usually absolutely vaporised. These liquid residues can be water, oil, etc.

In addition to the described cleaning effect, if necessary the heat source also ensures micro structuring of the surface of the device housing to the extent that the surface is roughened. Furthermore, by heat treatment on plastic surfaces in particular, polar bonds are released which favour subsequent adhesion of the sealant which is usually also polar. The same applies to the microstructures which also facilitate and favour adhesion of the sealant, without the need for additional adhesion agents in general, which usually need to be applied before application of the sealant. The manufacturing time is reduced and costs minimised where such adhesion agents can be dispensed with in accordance with the invention.

As already explained, the light emitted by the CO₂ laser typically used can be focussed if necessary. Then beam diameters in the region of approx. 100 μm to approx. 10 mm can be achieved. But it is also possible to work with the unfocussed beam diameter which is classed in the range between 3 mm to 20 mm without focussing.

The sealant is usually applied with the aid of a dispenser unit onto areas treated in such a way of the surface of the device housing. The sealant then generally hardens subsequently. The sealant thus adheres adhesively on the surface. The same applies to the hardened seal. The dispenser unit can be designed with a nozzle dispenser. Consequently, the sealant is applied in the form of a sealing bead onto the previously treated areas.

The invention recommends recourse to PUR (polyurethane) foam as sealing material. Actually, such polyurethane foams can be designed with a soft elastic to hard elastic character. In the first stated case, Shore 00 hardnesses of a maximum of 100 are observed. In contrast, a hard elastic design leads to Shore D hardnesses of approx. 50 and more.

The invention usually works with a PU foam the Shore 00 hardness of which is classed considerably below 100 and which has an especially marked soft elastic deformability, preferably Shore 00 hardness 50. That is of particular significance for the typically planned purpose of use, i.e. to seal a recess in a motor vehicle door or generally motor vehicle bodywork with the device housing attached behind.

The application of the sealant onto the external surface of the device housing is also easily possible in the case that the material surface in question is not manufactured of the same material, i.e. from plastic, but is, for example, designed on the basis of the different materials of plastic and metal. In fact, a design with such different materials is typically observed in a motor vehicle door lock housing. This is attributable to the fact that a housing lid is generally manufactured from plastic; in contrast, a lock box connected to the housing lid is manufactured from steel. In order to now equip such a device housing or motor vehicle door lock housing on the basis of steel/plastic with the sealant, heat treatment occurs in accordance with the invention with recourse to the CO₂ laser.

This also succeeds and especially for the steel lock box, although initially a more or less marked reflection of the emitted laser light is expected at this point due to the metallic character. In actual fact, the lock box in question typically has a coating of or with recourse to zinc and iron, by means of which the absorption compared to a metallically sheer steel surface is already considerably increased. Added to this is the fact that every isolated destruction of the surface increases absorption due to the multiple reflection. However, such device housings which are equipped at least partially from steel with the described zinc-iron coating can be easily pre-treated with the CO₂ laser. The situation for steel housings is comparable, whereby the steel has a matt, absorbent coating.

This applies all the more to the housing lid or a device housing made of plastic. Here, POM (polyoxymethylene) has proven especially beneficial as a suitable plastic. Such plastics are typically black in colour and therefore have a high absorption capacity for the emitted infrared rays and are particularly suited to the described treatment.

The object of the invention is also a device for application of a seal onto a surface of a device housing as described in Claim 13. Advantageous configurations of this equipment can be found in Claims 14 and 15.

As a result, a procedure and pertaining equipment are presented which provide an especially cost-effective and also functional production procedure with the help of which a seal can be defined on or in a device housing for a motor vehicle. Usually, an external surface of the device housing in question is completely or partially equipped with the seal in question. To this end, the surface in question is typically subjected to heat treatment with a CO₂ laser and undergoes cleaning and/or microstructuring in this regard.

Due to this fact, a sealant can be adhesively applied easily and directly onto the surface in question following this pre-treatment, usually without adhesive agents. The crucial advantages can be seen in this. Other features and advantages of the present invention will become apparent from the following detailed description, taken in conjunction with the accompanying drawings, which illustrate by way of example the principles of the invention.

### BRIEF DESCRIPTION OF THE DRAWINGS

The invention is explained in more detail hereinafter on the basis of a sketch merely outlining an execution example.

FIG. 1 shows a device housing in the form of a motor vehicle door lock housing with a seal applied to an external surface;

FIG. 2 shows a comparable object to FIG. 1 in a transformed execution form; and

FIG. 3 shows equipment diagrammatically with the help of which the seal is applied to the motor vehicle door lock housing.

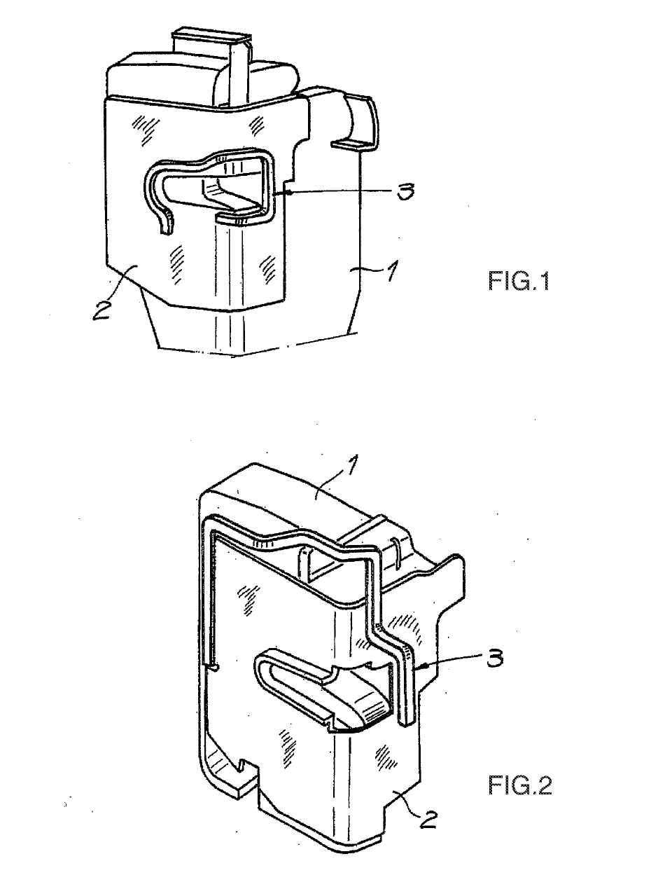

### DETAILED DESCRIPTION OF THE INVENTION

A device housing 1, 2 is depicted in the figures. This device housing 1, 2 is suitable for vehicles, and therefore typically serves the purpose of internally accommodating units, engines, etc. which can be found in or on a vehicle. As part of the execution example, the device housing 1, 2 is designed as a motor vehicle door lock housing 1, 2.

The depicted motor vehicle door lock housing 1, 2 comprises a so-called lock housing 1 and a lock box 2. The lock housing 1 is made of plastic, in the present case of POM (polyoxymethylene). In contrast, lock box 2 consists of steel and may also have a coating. This coating is usually zinc- and/or iron-based. Of course, this is not compulsory.

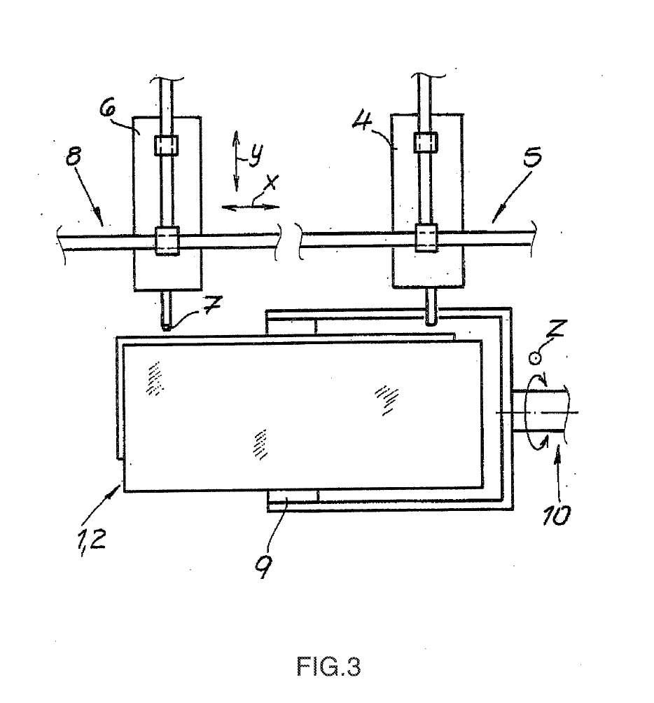

It is recognised that the device housing or motor vehicle door lock housing 1, 2 is equipped with a seal 3 on its external surface. The seal 3 has a three-dimensional shape and is applied to the device housing or motor vehicle door lock housing 1, 2 in question with the aid of the equipment depicted in diagrammatic form in FIG. 3. With the aid of seal 3, a recess is sealed in a lateral door of the motor vehicle behind which the motor vehicle door lock housing 1, 2 is accommodated.

In FIG. 3 a heat source 4 is initially recognised which is attached to an actuator 5. As part of the execution example, movements can be executed in x and y direction with the aid of the actuator 5 as indicated by relevant arrows in FIG. 3.

Furthermore, the device is equipped with a dispenser unit 6 for application of the seal 3 onto the device housing or motor vehicle door lock housing 1, 2. The dispenser unit 6 has one or several nozzle dispensers 7 at the outlet side, with the aid of which sealant can be applied to the device housing or the motor vehicle door lock device housing 1, 2 in accordance with the desired shape of the seal 3 manufactured by hardening.

As is the case for heat source 4 or the CO₂ laser envisaged at this point, the dispenser unit 6 is also connected to its own actuator 8—which, in a similar way to actuator 5—, permits setting movements in x and y direction. Of course, both setting directions 5 and 8 can fall into one another or be designed congruently if necessary.

The device housing or motor vehicle door lock housing 1, 2 is held with the aid of clamping fingers 9 which are components of a further actuator 10. This actuator 10 may be one which predominantly permits rotations of the device housing 1, 2 and also a movement of the device housing 1, 2 in Z direction. Once again, this is indicated by different arrows in FIG. 3.

It is thus achieved that heat source 4 and the surface of the device housing 1, 2 accomplish a mutual three-dimensional movement. This enables practically any desired shapes and designs of seal 3 to be accomplished by, for example, a hardening sealant being applied to the external surface of the device housing 1, 2 in the example with the aid of dispensing unit 6. At least one nozzle dispenser 7 serves this purpose.

This functionality is as follows. The surface, in the present case the external surface of the device housing 1, 2 is initially impacted with the aid of the heat source 4. The heat source 4 becomes or is restricted by area in the process. This can also be attributed to the narrowly outlined diameter of the laser beam which has a diameter in the region of 3 mm to 20 mm without focussing. By heat source 4 and/or device housing 1, 2 being three-dimensionally moved against one another with recourse to the respectively relevant actuator 5 or 10, the range of the external surface of the device housing 1, 2 subsequently covered by seal 3 can be treated in this way. The surface in the region of the subsequently applied sealant or in the region of the subsequently defined seal 3 thus experiences the described heat treatment. Furthermore, the surface in question is cleaned and/or micro structured as described.

Subsequently, the hardening sealant is applied to the areas of the surface of device housing 1, 2 treated in such a manner with the aid of the dispenser unit 6 or the nozzle dispenser 7. The heat source 4 or the dispenser unit 6 and the device housing 1, 2 can be moved against one another as described in order to be able to define any shaped treated areas and subsequently also applied seals 3.

The design is decided in such a way overall that the heat source 4 or the CO₂ laser in the example case only impacts the surface of the device housing 1, 2 near to the surface. In actual fact, processing takes place up to only 500 μm and especially 100 μm material depth for device housing 1, 2. In the present case, the CO₂ laser works in a pulsed manner with laser pulses of a duration in a range from one millisecond to 10 nanoseconds. The emitted wavelength is approx. 10.6 μm and is therefore classed in the near infrared range.

The sealing material or the subsequently manufactured seal 3 is made of PUR foam. This is directly applied to the previously treated surface of the device housing 1, 2 with recourse to the heat source 4 with the aid of the nozzle dispenser 7. This means that an adhesive agent or similar is not absolutely necessary. This even applies if the surface and consequently the device housing as described are made of different materials with the lock box 2 made of metal or steel and the lock housing 1 made of plastic.

It is to be understood that the above-described embodiment is illustrative of only one of the many possible specific embodiments which can represent applications of the principles of the invention. Numerous and varied other arrangements can be readily devised by those skilled in the art without departing from the spirit and scope of the invention.

1. A procedure for the application of a seal (3) onto a surface of a device housing (1, 2) for a motor vehicle, especially a motor vehicle door lock housing surface, comprising the following procedural steps;
the surface is at least partially cleaned and/or microstructured by a heat source (4) restricted in area; and
a sealant is applied to areas of the surface treated in such a way

2. The procedure in accordance with claim 1, wherein the surface of the device housing (1, 2) only experiences the described treatment in the area of the subsequently applied sealant.

3. The procedure in accordance with claim 1, wherein the heat source (4) and/or the surface of the device housing (1, 2) are moved against one another in order to define any shaped treated areas.

4. The procedure in accordance with claim 3, wherein the heat source (4) and/or the surface accomplish a mutual three-dimensional movement.

5. The procedure in accordance with claim 1, wherein the heat source (4) only impacts the surface in an area close to the surface up to 500 μm, for example, especially at a 100 μm material depth.

6. The procedure in accordance with claim 1, wherein the heat source (4) processes the surface in a pulsed manner.

7. The procedure in accordance with claim 1, wherein the heat source (4) works as an electromagnetic source of radiation which preferably emits in the infrared range

8. The procedure in accordance with claim 1, wherein an infrared laser, especially a CO₂ laser, is used as a heat source (4).

9. The procedure in accordance with claim 1, wherein the light emitted by the heat source (4) is focussed, for example on the radiation diameter in the region of approx. 100 μm to approx. 10 mm.

10. The procedure in accordance with claim 1, wherein the sealant is applied to the previously treated areas with the aid of nozzle dispenser (7) in the form of a sealing bead.

11. The procedure in accordance with claim 1, wherein a PUR foam is regularly applied directly to the treated surface of the device housing (1, 2) as a sealing material without additional aids.

12. The procedure in accordance with claim 1, wherein the surface of the device housing (1, 2) is designed with the same or different materials, for example on the basis of plastic and metal.

13. A device for the application of a seal onto a surface of a device housing (1, 2) for a motor vehicle, especially a motor vehicle door lock housing surface, preferably for the execution of the procedure in accordance with claim 1, comprising: a heat source (4) which treats the surface in a restricted area in terms of cleaning and/or microstructuring; and a dispenser unit (6) for the hardening sealant applied to the treated areas.

14. The device in accordance with claim 13, wherein the heat source (4) and/or the device housing (1, 2) are retained by at least one preferably three-dimensionally working actuator (5; 10) in order to guarantee mutual movability and to define any shaped seals (3).

15. The device in accordance with claim 13, wherein the heat source (4) is designed as an infrared laser, especially a CO₂ laser.
